(19) United States
(12) Patent Application Publication
(10) Pub. No.: US 2012/0120248 A1
(43) Pub. Date: May 17, 2012

(54) IMAGE PHOTOGRAPHING DEVICE AND SECURITY MANAGEMENT DEVICE OF OBJECT TRACKING SYSTEM AND OBJECT TRACKING METHOD

(75) Inventors: Min-ho HAN, Daejeon (KR); Su Wan PARK, Daejeon (KR); Jong-Wook HAN, Daejeon (KR); GEONWOO KIM, Daejeon (KR); Hong IL JU, Daejeon (KR); SuGil CHOI, Daejeon (KR); Jin Hee HAN, Daejeon (KR); Moo Seop KIM, Daejeon (KR); Young Sae KIM, Daejeon (KR); Yong-Sung JEON, Daejeon (KR)

(73) Assignee: Electronics and Telecommunications Research Institute, Daejeon (KR)

(21) Appl. No.: 13/297,759

(22) Filed: Nov. 16, 2011

(30) Foreign Application Priority Data
Nov. 16, 2010 (KR) 10-2010-0113891

(51) Int. Cl. H04N 5/225

(52) U.S. Cl. 348/169; 348/E05.024

(57) ABSTRACT

An image photographing device of an object tracking system includes: an image recognizing module for collecting image information within a field of view (FOV) region in real time, recognizing occurrence of an event from the collected image information to extract an object contributing to the occurrence of the event, and sensing whether the extracted object is out of the FOV region or not. The device further includes an object tracking module for extracting property of the object from the extracted object to generate metadata, storing the metadata in a database, and providing the metadata stored in the database to ambient image photographing devices based on the sensing result of the image recognizing module.

### CROSS-REFERENCE(S) TO RELATED APPLICATION

The present invention claims priority of Korean Patent Application No. 10-2010-0113891, filed on Nov. 16, 2010, which is incorporated herein by reference.

### FIELD OF THE INVENTION

The present invention relates to image security management, and more particularly, to an image photographing device and security management device of an object tracking system capable of tracking a travel path of an object using interlinked cameras and object tracking method.

### BACKGROUND OF THE INVENTION

In general, a closed circuit television (CCTV) is an image security system including a digital image storage device for storing a camera image, a monitor, and network. A conventional image security system simply stores images collected by a camera and enables an operator to manually monitor the stored images through a monitor, that is, it is a system that entirely depends on human beings to interpret the images. However, recently, with utilizing an intelligent image recognizing technology in the image security system, it is proposed a system for analyzing images collected in real time by a camera and sensing a meaningful event from the analysis.

Such intelligent image recognizing technology is loaded in a camera of the image security system to recognize an event occurred in the images that are collected in real time, to extract an object that contributes to the event, and to track the object within a field of view (hereinafter, referred to as ‘FOV’) in the same camera. However, when the object is out of the FOV of the camera, no further tracking is performed. That is, image processing between cameras is completely independent and tracking of an object by interlinking cameras is never considered.

### SUMMARY OF THE INVENTION

In view of the above, the present invention provides an image photographing device of an object tracking system and an object tracking method for transmitting metadata on an object to a neighboring camera and information on the object to a security management server when it is out of FOV, such that real-time tracking of the object is enabled by interlinking cameras.

Further, the present invention provides a security management server of the object tracking system capable of receiving information on an object by interlinking cameras that are multiple image photographing devices and generating a travel path of the object.

The objects of the present invention are not limited thereto, but all other objects that are not described above will be apparently understood by those skilled in the art from the following description.

In accordance with an aspect of the present invention, there is an image photographing device of an object tracking system including: an image recognizing module for collecting image information within a field of view (FOV) region in real time, recognizing occurrence of an event from the collected image information to extract an object contributing to the occurrence of the event, and sensing whether the extracted object is out of the FOV region or not; and an object tracking module for extracting property of the object from the extracted object to generate metadata, storing the metadata in a database, and providing the metadata stored in the database to ambient image photographing devices based on the sensing result of the image recognizing module.

In accordance with anther aspect of the present invention, there is provided a security management device of an object tracking system connected with multiple image photographing devices including: a database in which position information on each of the image photographing devices is stored; an information receiver for receiving information on an object contributing to occurrence of an event from any of the image photographing devices; and a travel path generator for generating a travel path of the object by using the position information of said any of the image photographing devices having transmitted the information on the object.

In accordance with still another aspect of the present invention, there is provided an object tracking method of an image photographing device including: when an object contributing to occurrence of an event exists within a field of view (FOV) region, extracting property of the object to generate metadata; storing the generated metadata in a database, and transmitting the metadata to a security management server connected via a wired/wireless communication network; and when the object is out of the FOV region, transmitting the metadata on the object to ambient image photographing devices.

### BRIEF DESCRIPTION OF THE DRAWINGS

The above and other objects and features of the present invention will become apparent from the following description of embodiments, given in conjunction with the accompanying drawings, in which:

FIG. 1 is a block diagram showing a real-time object tracking system using multiple IP cameras in accordance with an embodiment of the present invention;

FIG. 2 is a block diagram showing a configuration of an IP camera in accordance with the embodiment of the present invention;

FIG. 3 is a view illustrating color information of metadata that is generated by the IP camera in accordance with the embodiment of the present invention;

FIG. 4 is a view illustrating shape information of the metadata that is generated by the IP camera in accordance with the embodiment of the present invention;

FIG. 5 is a view illustrating travel information of the metadata that is generated by the IP camera in accordance with the embodiment of the present invention; and

FIG. 6 is a flowchart showing an operation process of the IP camera when an object is found in accordance with the embodiment of the present invention.

### DETAILED DESCRIPTION OF THE EMBODIMENT

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, an embodiment of the present invention will be described in detail with the accompanying drawings which form a part hereof.

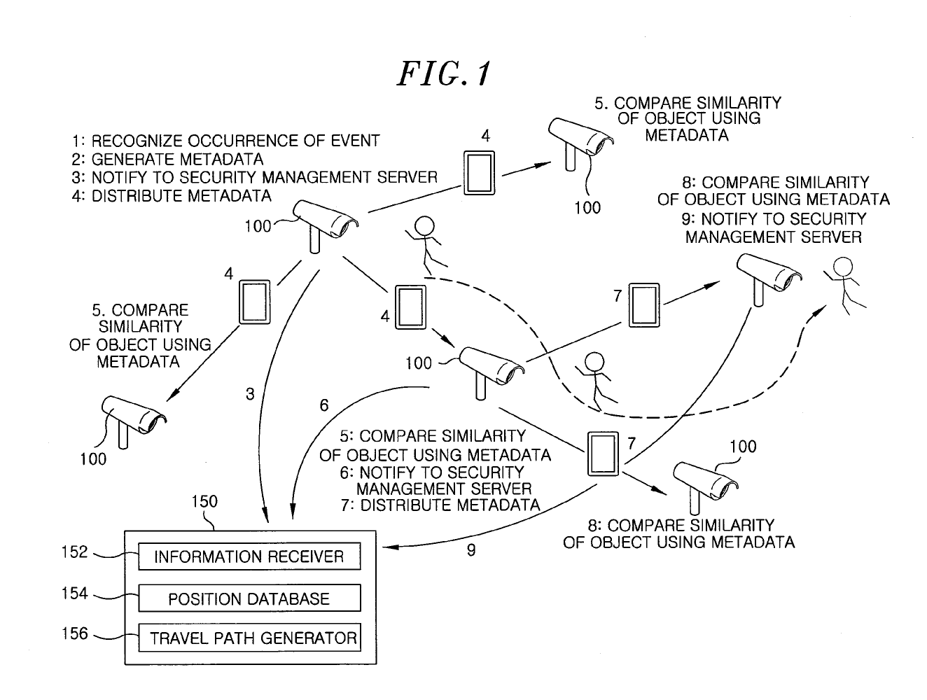

FIG. 1 is a block diagram showing a real-time object tracking system using multiple IP cameras in accordance with an embodiment of the present invention, which includes multiple IP cameras 100 and a security management server 150.

Each of the IP cameras 100 generates and distributes metadata including a property of an object within a predetermined radius and checks similarity between metadata that is provided from a neighboring IP camera and metadata on an object within the radius of the IP camera itself to notify the check result to the security management server 150.

The IP camera 100 in accordance with the embodiment of the present invention, as shown in FIG. 2, include an intelligent image recognizing module 200 for recognizing occurrence of an event from image information that is collected in real time and extracting an object that contributes to the event, an object tracking module 210 for extracting a property of the object from the extracted object to generate metadata, and a database 220 in which the generated metadata is stored.

The intelligent image recognizing module 200 notifies an event, when an object to be tracked is out of FOV of the IP camera 100 and is disappeared, to the object tracking module 210.

The object tracking module 210 in accordance with the embodiment of the present invention searches the database 220 for metadata on the disappeared object, distributes the searched metadata to ambient IP cameras 100 using position information of the ambient IP cameras 100, and stores the metadata received from the ambient IP cameras 100 in the database 220.

In addition, the object tracking module 210 may check similarity between the metadata on the object extracted from the intelligent image recognizing module 200 and the metadata stored in the database 220 to determine the object having similarity higher than a predetermined level as an object to be tracked, and transmit information regarding the object to the security management server 150.

The metadata used to track an object in real time using the IP cameras 100 in accordance with the embodiment of the present invention may be raw image data, e.g., data containing properties of an object that is extracted from the raw image data of few Mbytes that is processed with data of few Kbytes, such as color information, shape information, travel information, and other information.

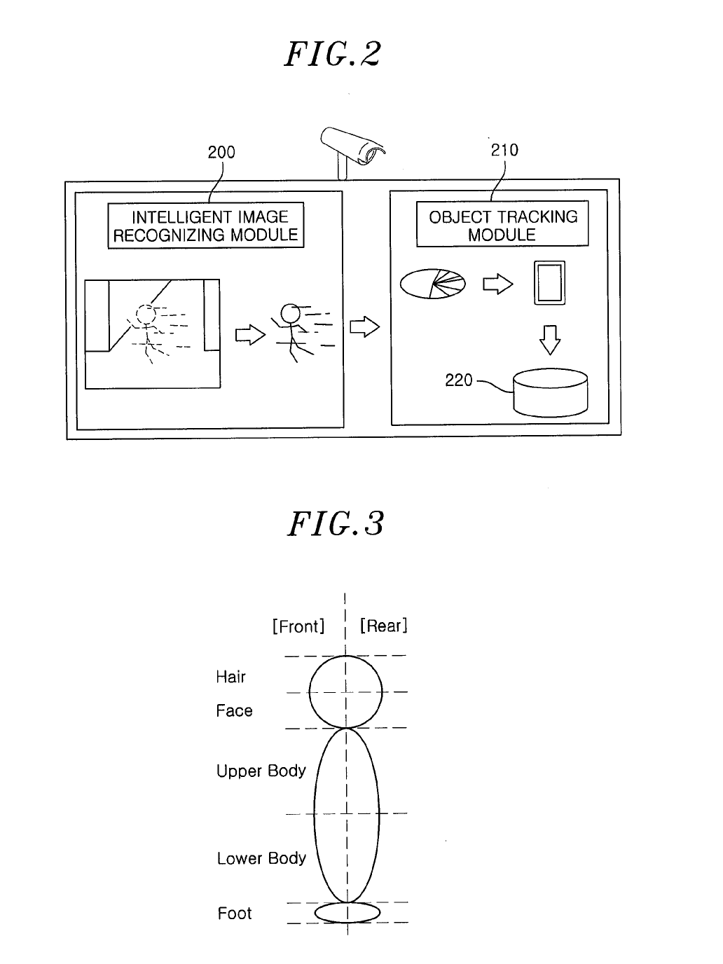

The metadata will be described with reference to FIGS. 3 to 6 as follows.

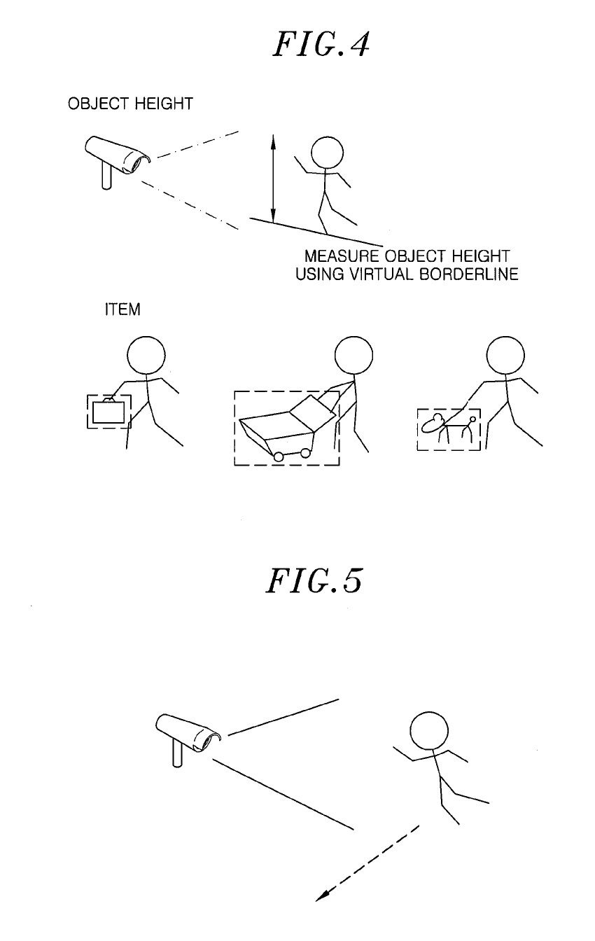

FIG. 3 is a view illustrating color information of metadata, FIG. 4 is a view illustrating shape information of the metadata, and FIG. 5 is a view illustrating travel information of the metadata, in accordance with the embodiment of the present invention.

Referring to FIG. 3, the color information includes ten entries when an object is a human being, roughly a front side and a rear side, each of which has hair, face, upper body, lower body, and foot. The front side is distinguished from the rear side because front color information of an object (human being) may be different from rear color information thereof when colors of front and rear sides of clothing are different from each other, when the object (human) carries a back pack in color different from that of the front side of his/her clothing, and when a necktie of which color is different from his/her clothing is worn. The front and rear sides of the object may be distinguished by face recognizing and traveling direction recognizing by the intelligent image recognizing module 200.

Although hair may be basically similar between objects (human beings), color information thereon may be different due to dyeing or a cap and color information on face may also be different due to a mask or muffler. Division such as upper body, lower body, and foot enables to classify color information based on borderlines between tops, bottoms, and shoes to thus compare detailed similarities of objects (human beings).

Referring to FIG. 4, the shape information consists of two entries when an object is a human being, that is, object height and an item. The object height is information on height of an object measured using a virtual borderline, may be basically used to determine whether an object is an adult or a kid, and may be subdivided when the intelligent image recognizing module 200 of the IP camera 100 is capable of more detailed measurement. The item is information of determining whether an object carries a thing on his/her hands and may be subdivided into, e.g. a bag, a baby carriage, a pup or the like when the intelligent image recognizing module 200 of the IP camera 100 can measure the same in detail.

Referring to FIG. 5, the travel information has one entry indicating a traveling direction of the object.

Other information of the metadata may have an entry such as a ratio of correctness when similarities of an object and the metadata are compared or an identifier of the metadata.

In order for the image security system to track an object in real time using multiple IP cameras, protocol for interlinking between devices of the image security system is required. The protocol for interlinking is asynchronous Request/Response message protocol operated on user datagram protocol (UDP) in transmission control protocol/internet protocol (TCP/IP) protocol stacks and is used to deliver messages between the security management server 150 and the IP cameras 100 and between the IP cameras 100. That is, a message for delivering position information of ambient IP cameras and for transferring information on an object to be tracked is used between the security management server 150 and the IP cameras 100 and a message for transferring metadata of an object being tracked is used between the IP cameras 100.

The security management server 150 generates information such as a travel path of an object or the like based on the position information of the IP camera 100 that transmits information on the object. To this end, the server 150 includes an information receiver 152, connected to the IP cameras 100 via a wired/wireless communication network, for receiving information on an object, a position database 154 in which the position information on the multiple IP cameras 100 connected to each other via the wired/wireless communication network is stored, a travel path generator 156 for generating the travel path of the object based on the received position information of the IP cameras 100 and the information on the object, and the like. In this case, the position information may be IP address allocated to the IP cameras 100.

Now, an operation process of the image tracking system will be described. As shown in FIG. 1, when, in the image tracking system, an IP camera 100 recognizes occurrence of an event from image information collected in real time (1), an object contributing to the event is extracted from the image information from which the occurrence of the event is recognized and metadata is then generated by extracting property of the object from the extracted object (2), and then information on the object is notified to the security management server 150 (3).

When the object contributing to the event is out of the FOV of a camera and disappeared, the metadata is distributed to neighboring IP cameras 100 for continuous tracking (4), and the IP cameras 100 having received the metadata checks similarity between the object in the images that are collected in real time and the distributed metadata (5).

When the object in the images collected in real time is matched to the metadata in similarity, the IP cameras 100 notify this to the security management server 150 (6), and when the object is out of the FOV of the IP cameras 100 and disappeared, they distributes the metadata to neighboring IP cameras 100 (7). The IP cameras 100 having received the metadata check similarity between the object in the images collected in real time and the metadata (8) and, when the object in the images collected in real time is matched to the metadata in similarity, they notify this to the security management server 150 (9). This method, namely, the generation and distribution of the metadata of the IP cameras 100 enable continuous tracking of the object even when the object contributing to the event is out of FOV of a specific one of the IP cameras 100, and the security management server 150 may track the travel path of the object contributing to the event using the information 3, 6, and 9 which is transferred from the IP cameras 100.

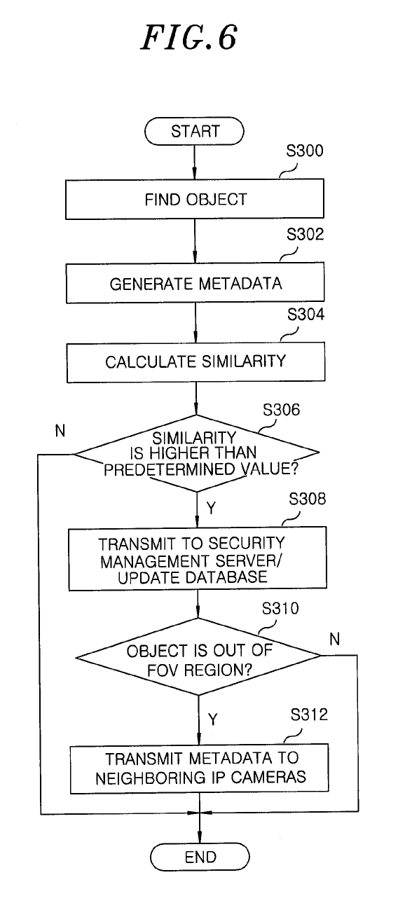

Meanwhile, a process that operates when the IP cameras 100 in accordance with the embodiment of the present invention find an object will be described with reference to FIG. 6.

FIG. 6 is a flowchart illustrating an operation process of the IP camera when an object is found in accordance with the embodiment of the present invention.

As shown in FIG. 6, the intelligent image recognizing module 200 of a specific IP camera 100 generates metadata on an object in step S302 when the object is found within its own FOV in step S300. The generated metadata is provided to the object tracking module 210.

Next, the object tracking module 210 calculates similarity by comparing metadata that is stored in the database 220 with metadata received from the intelligent image recognizing module 200 in step S304, and determines whether the calculated similarity is higher than a predetermined value in step S306.

When the calculated similarity is higher than the predetermined value as a result of the determination in step S306, the object tracking module 210 determines the object within the FOV region as the object to be tracked, transmits information on the object to the security management server 150, and updates the database 220 using the metadata on the object in step S308.

Thereafter, the intelligent image recognizing module 200 determines whether the object in the FOV region is disappeared, i.e., whether the object is out of the FOV region in step S310.

When the object is out of the FOV region as a result of the determination in step S310, the intelligent image recognizing module 200 notifies the result to the object tracking module 210. Then, the object tracking module 210 extracts the metadata on the object from the database 220 and transmits the extracted metadata to neighboring IP cameras 100 in step S312.

In accordance with the embodiment of the present invention, information on an object contributing to occurrence of an event is transmitted to the security management server 150 when the object enters FOV region, and metadata on the object is transmitted to neighboring IP cameras 100 when the object is out of the FOV region so that continuous tracking of an object is enabled by interlinking the IP cameras 100 without any operation of an operator.

As described above, the method in accordance with the present invention can overcome limitation of a method in which an operator manually monitors images of respective cameras, which are collected in real time, through a monitor under the environment of the image security system in which the number of cameras increases sharply.

That is, in accordance with the embodiment of the present invention, the image security system capable of continuously tracking an object by interlinking cameras, without any operation of an operator of the image security system, even when the object contributing to an event is out of FOV of the cameras, can be implemented.

While the invention has been shown and described with respect to the particular embodiments, it will be understood by those skilled in the art that various changes and modifications may be made without departing from the scope of the invention as defined in the following claims.

What is claimed is:

1. An image photographing device of an object tracking system comprising:
an image recognizing module for collecting image information within a field of view (FOV) region in real time, recognizing occurrence of an event from the collected image information to extract an object contributing to the occurrence of the event, and sensing whether the extracted object is out of the FOV region or not; and
an object tracking module for extracting property of the object from the extracted object to generate metadata, storing the metadata in a database, and providing the metadata stored in the database to ambient image photographing devices based on the sensing result of the image recognizing module.

2. The device of claim 1, wherein when metadata on a certain object is received from the ambient image photographing devices, the object tracking module stores the received metadata in the database.

3. The device of claim 2, wherein similarity is measured by comparing the generated metadata with the metadata stored in the database, and information on the extracted object is transmitted to a security management server connected via a wired/wireless communication network based on the measured similarity.

4. The device of claim 1, wherein the object tracking module transmits information on the extracted object to a security management server connected via a wired/wireless communication network after generating the metadata.

5. The device of claim 3, wherein the device performs communications with the security management server using an asynchronous message protocol that is operated on user datagram protocol (UDP) of transmission control protocol/internet protocol (TCP/IP) protocol stacks.

6. The device of claim 4, wherein the device performs communications with the security management server using an asynchronous message protocol that is operated on user datagram protocol (UDP) of transmission control protocol/internet protocol (TCP/IP) protocol stacks.

7. The device of claim 1, wherein the device performs communication with an image photographing device connected to the device itself using an asynchronous message protocol that is operated on UDP of TCP/IP protocol stacks.

8. The device of claim 1, wherein the metadata includes color information, shape information, travel information on the object, and a ratio of correctness or identifier of the metadata.

9. The device of claim 7, wherein the color information includes a front side and a rear side, each of which has hair, face, upper body, lower body, and foot when the object is a human being.

10. The device of claim 7, wherein the shape information includes object height and an item which is information of determining whether the object carries a thing on his/her hands when the object is a human being.

11. A security management device of an object tracking system connected with multiple image photographing devices, the device comprising:
a database in which position information on each of the image photographing devices is stored;
an information receiver for receiving information on an object contributing to occurrence of an event from any of the image photographing devices; and
a travel path generator for generating a travel path of the object by using the position information of said any of the image photographing devices having transmitted the information on the object.

12. The device of claim 11, wherein the device performs communications with the image photographing devices using an asynchronous message protocol that is operated on user datagram protocol (UDP) of transmission control protocol/internet protocol (TCP/IP) protocol stacks.

13. An object tracking method of an image photographing device comprising:
when an object contributing to occurrence of an event exists within a field of view (FOV) region, extracting property of the object to generate metadata;
storing the generated metadata in a database, and transmitting the metadata to a security management server connected via a wired/wireless communication network; and
when the object is out of the FOV region, transmitting the metadata on the object to ambient image photographing devices.

14. The method of claim 13, further comprising:
when a certain object enters the FOV region, generating metadata on the certain object;
when metadata exists in the database, calculating similarity between the metadata on the certain object and the metadata stored in the database; and
transmitting information on the certain object to the security management server based on the similarity, and updating the database with the metadata on the certain object.

15. The method of claim 13, further comprising:
generating, at the security management server, a travel path of an object contributing to occurrence of an event by using position information of an image photographing device having transmitted the information on the object.
